(19) United States
(12) Patent Application Publication
(10) Pub. No.: US 2025/0209556 A1
(43) Pub. Date: Jun. 26, 2025

(54) FIRE PROTECTION ASSET IDENTITY AND MANAGMENT

(71) Applicant: FST INNOVATION PTY LTD, Melbourne, Victoria (AU)

(72) Inventor: Shae METE, Melbourne (AU)

(73) Assignee: FST INNOVATION PTY LTD, Melbourne, Victoria (AU)

(21) Appl. No.: 18/847,498

(22) PCT Filed: Mar. 16, 2023
(86) PCT No.: PCT/AU2023/050182

§ 371 Date: Sep. 16, 2024

(30) Foreign Application Priority Data
Mar. 16, 2022 (AU) 2022900638

(51) Int. Cl. G06Q 50/26; G06K 19/06; G06K 19/07

(52) U.S. Cl. CPC G06Q 50/265; G06K 19/06037; G06K 19/0723

(57) ABSTRACT

A fire protection asset comprising a machine-readable fire protection asset comprising a machine-readable code or tag disposed thereon, the machine-readable code or tag comprising fire protection asset information comprising a unique identifier for each respective machine-readable fire protection asset is provided. Also provided is a fire protection system comprising a plurality of machine-readable fire protection assets, each asset comprising a machine-readable code or tag disposed thereon and at least one reading device for reading the machine-readable code or tag, the reading device configured to send and/or receive fire protection asset information from and/or to one or more database. The system may further comprise the one or more which may be connected to a network and may be configured to allow entry of additional unique identifiers for additional machine-readable fire protection assets. The entry may be in response to fire protection asset information received from the at least one reading device.

### CROSS-REFERENCE TO RELATED APPLICATIONS

This application is a 371 U.S. National Phase of International Application No. PCT/AU2023/050182, filed on Mar. 16, 2023, which claims priority to Austrialian patent application Ser. No. 20/229,00638, filed on Mar. 16, 2022, both of which are incorporated by reference herein.

### TECHNICAL FIELD

The present invention relates to a fire protection asset comprising a machine-readable code or tag and to a fire protection system comprising one or more fire protection asset comprising a machine-readable code or tag. More particularly, in one embodiment, this invention relates to a fire protection system comprising one or more fire protection asset, each asset comprising a machine-readable code or tag such as, an RFID (Radio Frequency Identification) tag or a QR (Quick Response) code.

### BACKGROUND

Fire protection systems have an excellent track record of controlling fires. When they are properly designed, installed, certified, inspected and maintained they drastically reduce both loss of life and property damage.

Many modern buildings are fitted with fire protection systems. These fire protection systems can be tailored to suit the needs of a particular site. The component parts of fire protection systems include: sprinklers; flow meters; various valves such as, shut off valves, flow valves, isolation valves and drain valves; gauges; valve monitors; pumps; switches such as, pressure switches and flow switches; smoke detectors; sirens; pull stations; control points; intercom points; carbon monoxide monitors; carbon dioxide monitors; heat detectors; and passive fire protection components.

Passive fire protection components are those components which contain a fire to a room of origin or similarly contain, or seek to contain, a fire to a limited area. These components include vertical fire and smoke compartment barriers; horizontal fire and smoke compartment barriers; openings; fire door sets including fire doors, including sliding fire doors; smoke doors; ducts; dampers; fire shutters; access panels and hatches; service penetrations; control joints; fire-resistant glazing; fire stopping and structural fire-resistant elements such as, beams, columns and trusses.

One prominent component of these fire protection system is the fire sprinklers, many thousands of which may be installed in a large building. It is the fire sprinklers that ultimately deliver the fluid to extinguish any fire. For this reason, and the large number which may be installed at a particular site, there is data available documenting their failure. For instance, there are documented instances where non-compliant or inoperative sprinkler installations have resulted in both loss of life and property damage.

Between the years 2015 and 2019 in the US, 25% of all sprinkler failures (750 per year failed to operate) in the US were due to damaged system components (9%), inappropriate system selection (6%), or a lack of maintenance (10%). During the same period, 17% of all events where sprinklers operated ineffectively (340 per year) due to lack of maintenance (3%), damaged system components (7%), and inappropriate system selection (7%)¹. In the same time-period in the US, out of 27,151 recorded non-confined structure fires where sprinklers were present, there were 57 civilian deaths, 1,426 injuries, and US$2.6 B in direct property damage². There were three civilian deaths from ineffective operation and three civilian deaths from a failure to operate². Again, in that time period, it was reported that the average direct property loss per fire associated with any type of sprinkler was 11% lower (US$2,400) than without automatic extinguishing systems (AES), and 7% lower (US$1,600) for wet-pipe sprinklers specifically (noting that these figures vary across property use) 3.

U.S. Pat. No. 11,126,966 to TEGRIS INC is directed to a method using a web registry to track the inspection compliance of a street fire hydrant of the type used by fire fighters and owned by the water authority. Street fire hydrants are equipped with an RFID chip to transmit inspection data to a handheld device. This cataloguing is performed to allow firefighters to rapidly determine which nearby hydrants are available for use and properly functioning.

US patent publication 2019/0024352 to Ozburn teaches a highly visible flexible cover for a street fire hydrant. The high visibility cover aids in spotting or locating the street fire hydrant in case of emergency use to fight a fire. These high visibility covers may be equipped with an identification device such as, an RFID tag, configured to provide pertinent characteristics or operation information, for example location, proximity, flow rate, pressure and the like.

There remains a need for alternative fire suppression devices, methods and systems to provide a more efficient method of identifying and logging service records for more complex and highly integrated fire protection systems and equipment installed in modern buildings.

The reference to any prior art in this specification is not, and should not be taken as, an acknowledgement or any form of suggestion that the prior art forms part of the common general knowledge.

### SUMMARY

Generally, embodiments of the present invention relate to a fire protection asset comprising a machine-readable code or tag and to a fire protection system comprising one or more fire protection asset comprising a machine-readable code or tag.

In one broad form, the invention relates to a fire protection asset such as, a fire sprinkler, comprising one or more machine-readable code or tag. In another broad form, the invention relates to a fire protection system comprising one or more fire protection asset, each asset comprising a machine-readable code or tag such as, an RFID (Radio Frequency Identification) tag or a QR (Quick Response) code.

In one aspect, although it need not be the only or indeed the broadest form, the invention provides a fire protection asset comprising:
a machine-readable fire protection asset comprising a machine-readable code or tag disposed on the machine-readable fire protection asset, the machine-readable code or tag comprising fire protection asset information for the machine-readable fire protection asset on which the machine-readable code or tag is disposed, the fire protection asset information comprising a unique identifier for each respective machine-readable fire protection asset.

In a second aspect, the invention provides a fire protection system comprising:
a plurality of machine-readable fire protection assets, each asset of the plurality comprising a machine-readable code or tag disposed on the respective machine-readable fire protection asset, the machine-readable code or tag comprising fire protection asset information for the respective machine-readable fire protection asset on which the machine-readable code or tag is disposed, the fire protection asset information comprising a unique identifier for each respective machine-readable fire protection asset; and
at least one reading device for reading the machine-readable code or tag, the reading device configured to send and/or receive fire protection asset information from and/or to one or more database.

The system of the second aspect may further comprise the one or more database comprising fire protection information and fire protection asset information. The one or more database may be connected to a network for operative communication with the at least one reading device. The one or more database may comprise the unique identifier for each respective machine-readable fire protection asset. The one or more database may be configured to allow entry of additional unique identifiers for additional machine-readable fire protection assets. The entry may be in response to fire protection asset information received from the at least one reading device.

In a third aspect, the invention provides a method for installing or establishing a fire protection system, the method comprising:
installing a plurality of machine-readable fire protection assets, each asset of the plurality comprising a machine-readable code or tag disposed on the respective machine-readable fire protection asset, the machine-readable code or tag comprising fire protection asset information for the respective machine-readable fire protection asset on which the machine-readable code or tag is disposed, the fire protection asset information comprising a unique identifier for each respective machine readable fire protection asset; and
providing at least one reading device for reading the machine-readable code or tag, the reading device configured to send and receive fire protection asset information from one or more database.

In a fourth aspect, the invention provides a fire safety method, the method comprising:
reading with a reading device a plurality of machine-readable fire protection assets, each asset of the plurality comprising a machine-readable code or tag disposed on the respective machine-readable fire protection asset, the machine-readable code or tag comprising fire protection asset information for the respective machine-readable fire protection asset on which the machine-readable code or tag is disposed, the fire protection asset information comprising a unique identifier for each respective machine readable fire protection asset.

In a fifth aspect, the invention provides a computer-implemented method for determining a fire safety attribute, the method comprising:
interrogating one or more database comprising fire protection asset information, the fire protection asset information comprising a unique identifier for each fire protection asset; and
providing a result extracted from the one or more database, the result comprising at least the unique identifier for each fire protection asset and the fire safety attribute to thereby determine the fire safety attribute.

In a sixth aspect, the invention provides a non-transitory computer program product comprising:
a computer usable medium and computer readable program code embodied on said computer usable medium for determining a fire safety attribute, the computer readable code comprising:
computer readable program code devices (i) configured to cause the computer to interrogate one or more database comprising fire protection asset information, the fire protection asset information comprising a unique identifier for each fire protection asset; and
computer readable program code devices (ii) configured to cause the computer to provide a result extracted from the one or more database, the result comprising at least the unique identifier for each fire protection asset and the fire safety attribute to thereby determine the fire safety attribute.

The fifth or sixth aspects aspect may comprise receiving a query, the query forming the basis of the interrogation.

In a seventh aspect, the invention provides a computer server-based system for determining a fire safety attribute, the system comprising:
one or more server adapted to receive a query comprising at least one unique identifier for a machine-readable fire protection asset;
a processor to cause the computer to interrogate one or more database comprising fire protection asset information, the fire protection asset information comprising a unique identifier for each fire protection asset, the interrogation based on the received query; and
the one or more server adapted to provide a result extracted from the one or more database, the result comprising at least the unique identifier for each fire protection asset and the fire safety attribute to thereby determine the fire safety attribute.

According to any one of the fifth, sixth or seventh aspects, the at least one unique identifier may be received from the at least one reading device.

According to any one of the fifth, sixth or seventh aspects, the fire safety attribute determined may comprise counterfeit status or genuine part status. The counterfeit status or genuine part status may be determined using a unique serial number and/or the unique identifier for each fire protection asset. The unique serial number or a concordance may be provided by a remote database. The remote database may comprise a certification agency database. The unique serial number may be received by a certification agency and/or the remote database during or after manufacture of each fire protection asset.

According to any one of the second, third, fourth, fifth, sixth and seventh aspects the one or more database may be updated with the unique identifier for each respective machine-readable fire protection asset. The updating may be in response to fire protection asset information received from the at least one reading device.

The method according to any one of the second to seventh aspects, may further comprise connecting the at least one reading device to the one or more database through a network. The at least one reading device may transmit at least part of the read fire protection asset information to the network and/or one or more database. The at least part of the read fire protection asset information may comprise the unique identifier and/or the unique serial number. The at least one reading device may receive fire protection asset information from the one or more database. The at least one reading device may be a designated device or a mobile computing device such as a mobile phone or tablet computer. The at least one reading device may write to the machine-readable code or tag. The writing may be at the time of installation of the machine-readable fire protection asset.

According to any one of the above aspects, the machine-readable code or tag may be disposed on a body or casing of the fire protection asset.

According to any one of the above aspects, the one or more database may store the fire protection information for the machine-readable fire protection asset and for each respective machine-readable fire protection asset in the plurality of machine-readable fire protection assets. The one or more database may be remotely located. The one or more database may store a larger subset of fire protection information for each fire protection asset than stored on the machine-readable code or tag.

According to any one of the above aspects, the at least one reading device may comprise an extendible antenna or extendible rod to aid in reading codes or tags in elevated or otherwise hard to read positions. The at least one reading device may be comprised on a drone or adapted for deployment on a drone.

According to any one of the above aspects, the machine-readable code or tag may be retro-fit to the respective machine-readable fire protection asset. The retro-fit may be prior, during or after installation.

In one particular embodiment of any one of the above aspects, the fire protection asset may be located within a privately owned building. The fire protection asset located within a privately owned building may be part of a privately owned fire protection system. The fire protection asset located within a privately owned building may be connected to on-site water or part of a system connected to on-site water. The fire protection asset located within a privately owned building may be connected to water downstream of a water utility network.

In another particular embodiment of any one of the above aspects, the fire protection asset may be automatically activated. The automatic activation may be by a temperature responsive element. The automatic activation may comprise one or more automatically activated alarm. The one or more automatically activated alarm may comprise an external alarm monitoring service and/or the automatic summonsing of fire response such as, a fire brigade crew. The one or more automatically activated alarm may comprise a local alarm or alert in the form of a local audible alarm. One or more, or all components, of the automatically activated alarm may be regulated by a building code and/or standard.

In yet another particular embodiment of any one of the above aspects, the fire protection asset may be both located within a privately owned building and automatically activated.

According to any one of the above aspects, the fire protection asset may comprise a sprinkler; a flow meter; a valve such as, a shut off valve, a flow valve, an isolation valve or a drain valve; a gauge; a valve monitor; a pump; a switch such as, a pressure switch or a flow switch; a smoke detector; a siren; a pull station; a control point; an intercom point; a carbon monoxide monitor; a carbon dioxide monitor; a heat detector; or a passive fire protection component. The passive fire protection component may comprise a vertical fire and smoke compartment barrier; a horizontal fire and smoke compartment barrier; a fire-resistant opening; a fire door set including a fire door, including a sliding fire door; a smoke door; a duct; a damper; a fire shutter; an access panel; a hatch; a service penetration; a control joint; a fire-resistant glazing; an alarm; a fire stopping or a structural fire-resistant element such as, a beam, a column and a truss.

In one particular embodiment of any one of the above aspects, the fire protection asset may be a fire sprinkler or fire sprinkler head; or fire sprinkler adaptor. In other embodiments the fire protection asset may comprise a smoke detector and/or gas detector. The smoke detector and/or gas detector may provide data through a SIM card.

In one particular embodiment of any above aspect, the machine-readable code or tag may be one or more of an RFID chip; a QR code; a bar code or a SIM card. The machine-readable code or tag may be read only (RO) or read and write (RW). The machine-readable code or tag may comprise any automatic identification and data capture (AIDC) device such as, a SIM card or sensor. The machine-readable code or tag may be active, powered by a battery, or passive, powered by the reading by the one or more reader. The machine-readable code or tag may comprise an on-asset data carrying device.

In another particular embodiment of any one of the above aspects, the fire protection information may comprise one or more of: fire protection asset information; and installation location information.

In still another embodiment of any one of the above aspects, the fire protection asset information may comprise one or more of: product code; manufacturer information; unique serial number; asset type; asset performance data; asset specification data; installation location; installation date data; inspection date; maintenance or service data; batch information; hardware information; frequency of use data; operating environment data; other production information; a photograph; and installer data. The manufacturer information may comprise one or more of: manufacturer name; factory name; and factory location. The installer data may comprise one or more of installer name; installer email, installer company name, installer phone number, installer license and/or accreditation. The frequency of use data may comprise designation of one or both of high-use or constant-use. The operating environment data may comprise designation of adverse operating environment status. The asset specification data may comprise asset warranty and/or asset longevity information. The photograph may comprise a photograph of the fire protection asset before and/or after installation.

In another embodiment of any one of the above aspects the installation location information may comprise one or more of: building address; internal location of the fire-protection asset; risk rating; occupancy type; GPS coordinates; height of the fire-protection asset above the floor; design standard; drawings of the installation location; general drawings; and associated schedules; and reference to a database or list of regulations or standards to confirm compliance. The installation location information may further comprise information required for compliance for the installation location such as, state or country location; nearby hazard or other nearby fixture affecting sprinkler type selection; and approved fire protection assets. The information required for compliance may comprise adequate documentation to conduct an inspection. The general drawings may be marked with relevant fire protection information. The internal location may comprise a floor and/or room. The risk rating may be a risk rating of one or more of the installation room; the installation area; the installation floor; and installation building. The design standard may be a design standard for the fire-protection asset dictated by the installation location or a regulation or code determined by the installation location.

In a particular embodiment of any one of the above aspects, the unique identifier may be used to query the at least one database to identify the installation location where the relevant fire-protection asset is installed. The identification of the installation location may permit access to change the fire protection information in the database for each respective fire-protection asset associated with the identified installation location.

In one particular embodiment, the installation location information may be reviewed to provide an approved replacement fire protection asset when replacement is required or detected to be required.

In yet another particular embodiment, the maintenance or service data may comprise a level of maintenance or service data and/or a frequency of maintenance or service data.

In one embodiment of any of the above aspects, the fire protection asset information is programmed into the code or tag at the time of manufacture of the machine-readable fire-protection asset or of the code or tag. The fire protection asset information, or a subset thereof, may be indelible and/or password protected. The subset may comprise the unique serial number and/or a unique identification.

In another embodiment of any one of the above aspects, the machine-readable code or tag comprises any automatic identification and data capture format.

In a particular embodiment of any one of the above aspects, the one or more database may be queried by one or more of the fire protection asset information and/or one or more of the installation location information. The query may be received and a response prepared, the response comprising all information in the one or more database associated with the queried one or more of the fire protection asset information and/or the installation location information. The query may be automatic upon reading of a machine-readable code or tag. The query may be for a fire safety attribute.

In another embodiment of any one of the above aspects, the device or system further comprises the one or more database providing an electronic alert when a date or time-period associated with the stored one or more of the fire protection asset information and/or the one or more installation location information stored in the one or more database. The date or time-period may be associated with one or more of inspection; testing; maintenance; and replacement activities.

In another embodiment, the fire protection information and/or fire protection asset information may be queried to provide a desired output. The desired output may comprise identification and/or listing of the fire protection assets associated with the query.

In one particularly advantageous embodiment of any one of the above aspects, a report detailing the received and/or sent fire protection asset information or a subset thereof may be provided. The report may further contain other information from the one or more database. The report may be provided electronically.

In another particularly advantageous embodiment of any of the above aspects, a message may be sent and/or an alert produced when a date is within a reminder period. The date may comprise end of warranty; expiry date or end of asset longevity date. The reminder period may comprise one or more of six months; three months; one month; two weeks; and one week.

In yet another particularly advantageous embodiment of any of the above aspects, a message may be sent and/or an alert produced when the asset is identified as being subject to a recall or other installation advisory note. The other installation advisory note may comprise one or both of: a changed maintenance or inspection practise and identification of counterfeit fire-protection asset.

In still another particularly advantageous embodiment of any one of the above aspects, a message may be sent and/or an alert produced when an action is determined to be overdue. The action may comprise one or more of: inspection; testing; maintenance; and other integrity process.

Further aspects and/or features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1A: shows one embodiment of a fire sprinkler featuring an RFID tag according to the invention.

FIG. 1B: shows the sprinkler of FIG. 1A, with an RFID tag and cover for the RFID tag shown disassembled.

FIG. 2: shows one embodiment of a code or tag on an asset according to the invention being read.

FIG. 3: is a flowchart showing data flow according to one embodiment of the invention.

FIGS. 4A to 4V: are screen images of one embodiment of an application running on a mobile phone according to one embodiment of the invention.

FIGS. 5A and 5B: show one embodiment of a mobile computing device and network according to the invention.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION

Embodiments of the present invention relate to fire protection assets comprising a machine-readable code or tag and to a fire protection system comprising one or more fire protection asset comprising a machine-readable tag or code.

Although the invention will be described with reference to a fire protection asset in the form of a fire sprinkler comprising one or more machine readable code or tag and to a fire protection system comprising a plurality of these sprinklers, it is not so limited.

As used herein, a “code” is any system of rules to convert information such as, a letter, word or image into another form, sometimes shortened or secret, for communication through a communication channel or storage in a storage medium. The information may be encoded as a unique identifier in for example, a matrix code or a barcode. A suitable example of a matrix barcode is a QR code.

As used herein, a “tag” is any unique identifier attached to an object. A tag may be distinguished from a code by not having to be within the line of sight of the reader.

The fire protection information, including both fire protection asset information and installation location information may be programmed into the code or tag at the time of manufacture. Advantageously, this information, or a subset thereof, may be indelible and/or or otherwise password protected to prevent unintended or unauthorised changes.

This fire protection information may be read from the asset using a reader device which, combined with an application on the reader or connected mobile phone or tablet, allows the operator to confirm details of the fire protection asset, its history, and its production, including verifying authenticity.

Data exchanges may occur between the code or tag, the reader and the one or more database allowing for the collection, storage, and recall of fire protection asset production, installation, installer, location, maintenance, and replacement data such that, combined, the solution offers unique potential to improve maintenance practices to the fire protection service industry.

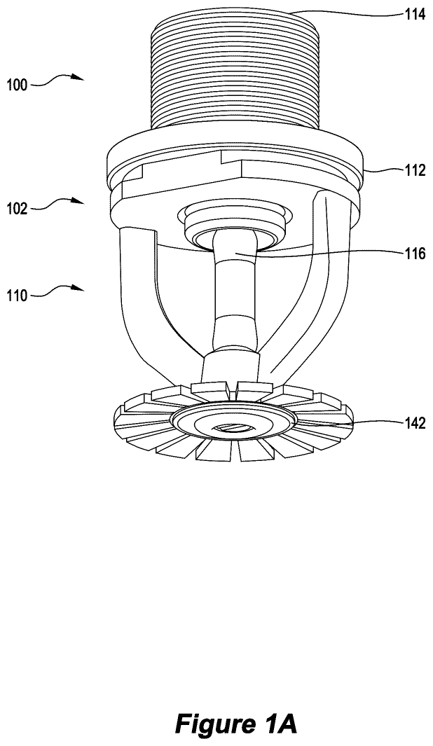

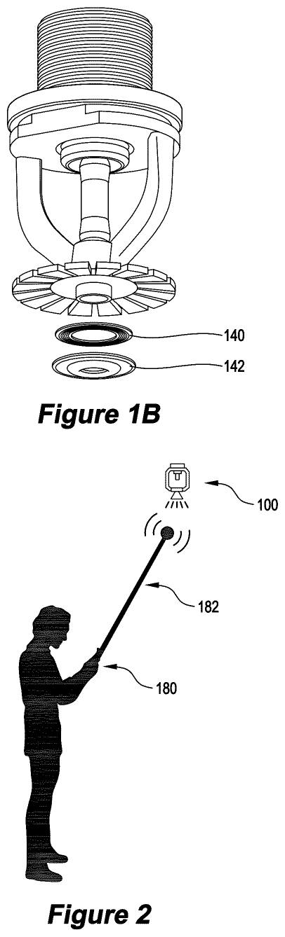

FIGS. 1A and 1B show one embodiment of a fire sprinkler 100 comprising a RFID tag 140 disposed on sprinkler body 102 according to the invention. While FIG. 1A shows the RFID tag installed and hidden underneath cover 142, FIG. 1B shows sprinkler 100 with an RFID tag 140 and cover 142 for the RFID 140 tag shown disassembled.

The sprinkler 100 is one example of a machine-readable fire protection asset comprising a machine-readable code or tag, in the form of an RFID tag 140, the tag disposed on the machine-readable fire protection asset and the tag 140 comprising fire protection asset information for the sprinkler 100, the fire protection asset information comprising a unique identifier for the sprinkler 100.

In FIG. 1 the RFID tag 140 is disposed on a body 102 of the sprinkler 100. In other embodiments, or with other asset types, the tag or code may be disposed similarly on a body or casing of the fire protection asset.

FIG. 2 shows a reading device 180, in the form of a hand-held reader with an extendible RFID reader antenna wand 182, being used to read RFID tag 140 on sprinkler 100. The reading device 180 may be a designated device or a mobile computing device such as, a mobile phone or tablet computer. If the tag or code permits, reading device 180 may write to the machine-readable code or tag 140. This writing may be at the time of installation of the machine-readable fire protection asset.

Similarly, the machine-readable code or tag may be fitted to the fire protection asset, such as the sprinkler 100, at the time of manufacture of the asset or retro-fitted at a time prior to, during or after installation.

In other embodiments, the at least one reading device 180 may comprise an extendible rod to aid in reading codes or tags in elevated or otherwise hard to read positions, or the at least one reading device 180 may be comprised on a drone or adapted for deployment on a drone.

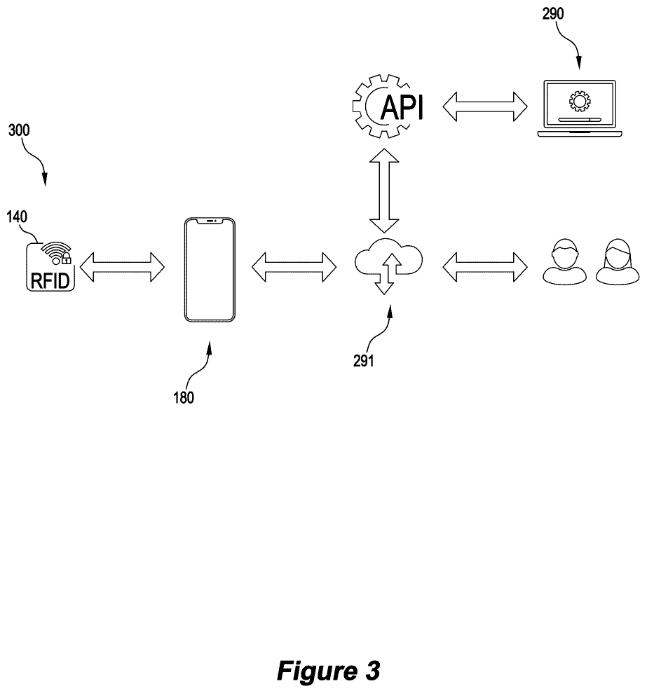

In FIG. 3 is shown one embodiment of data flow within one embodiment of a fire protection system 300 according to the invention. Data may be collected during asset production, installation, maintenance & repair operations, and commissioning to track the fire protection asset throughout its useful life, with data stored and indexed within one or more database.

The RFID tag 140 is shown in FIG. 3 to be an on-asset data carrying device. The data carried may be the fire protection information such as, the fire protection asset information and/or installation information or any subset thereof.

From the API location shown in FIG. 3, an interface to data for integration to building information systems, construction project management tools, risk management tools and fire system maintenance and mobile trades management applications is provided.

The one or more database 290 shown in FIG. 3 may provide data sharing for integration with third party job scheduling, Fire Protection System (FPS) asset maintenance software and mobile trades management applications. The data may be shared with regulators and other industry participants using the same or a similar RFID identification approach to improve FPS maintenance practices.

While the reading device 180 is pictured as a mobile phone in FIG. 3, from the teaching herein, a skilled person is readily able to select other suitable forms. The reading device 180 may be used for functions such as logging in; entering user credentials; entering site locations; entering identification information; entering maintenance pass or fail results; entering test results and entering risk ratings. These functions may be performed not only by a reading device 180 but may also be performed by a user terminal 291.

FIG. 3 also shows a server computer 291 which may be a cloud-based server. Such a server computer may provide data such as production and manufacture records, asset type, installation and installer data by site, historical maintenance and inspection activity logs, user credentials and reporting.

As shown in FIG. 3, represented by the icon of two people, the invention may also provide a web portal providing access to data including that for the reporting and user interface for production, the maintainer and other end-users.

Advantageously, installers may be prompted to register the installation of the fire protection asset upon installation and/or commissioning and then to use the application to record maintenance and inspection operations such as, including testing using approved test hardware devices during the asset's useful life.

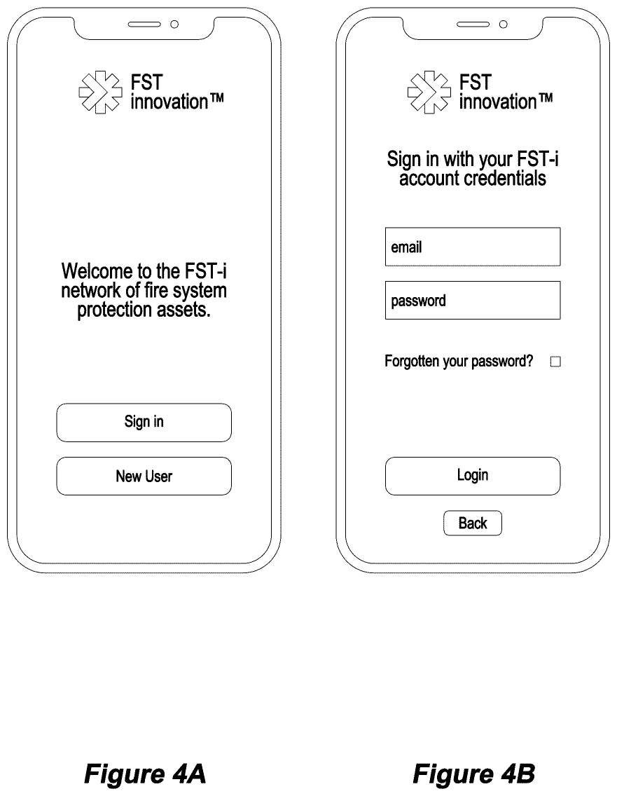

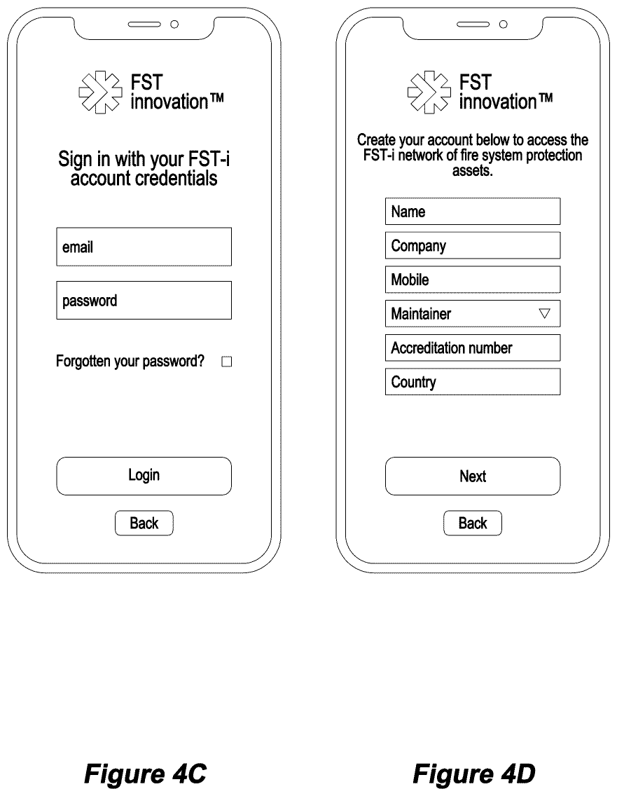

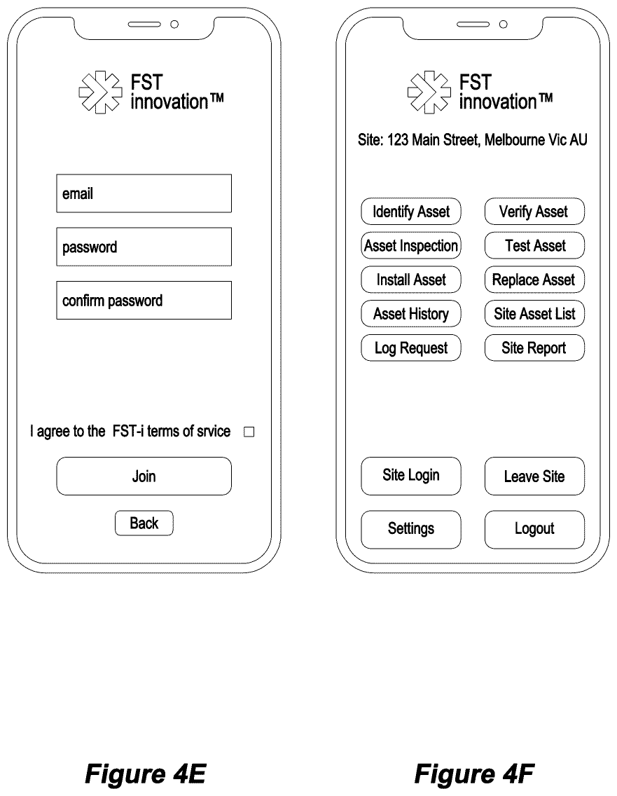

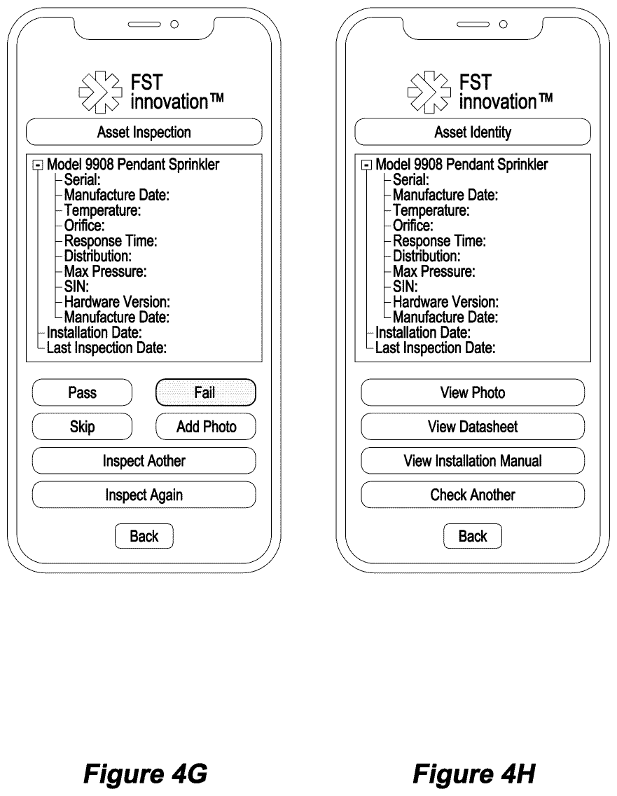

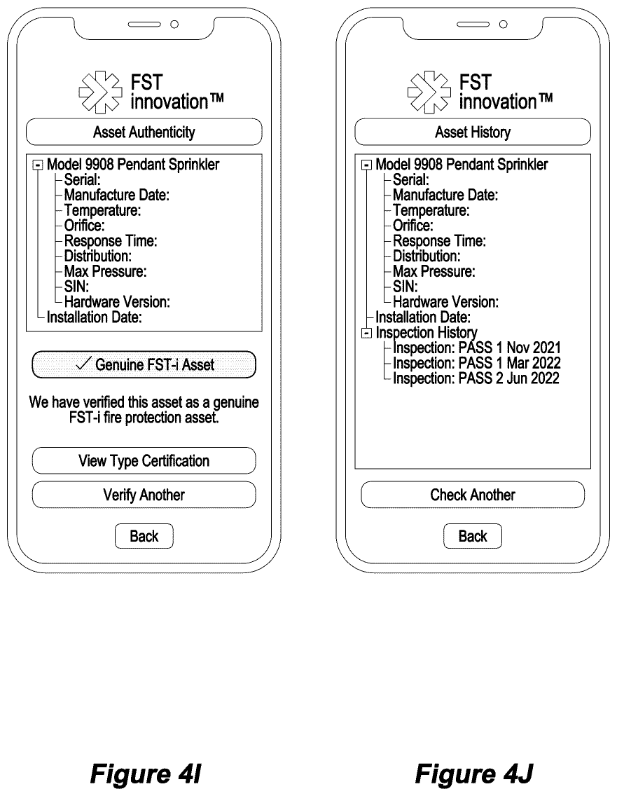

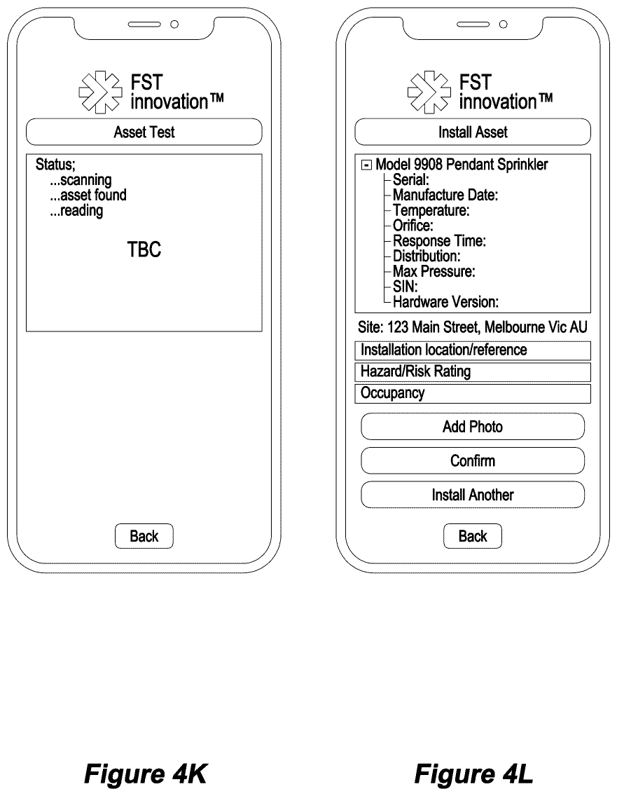

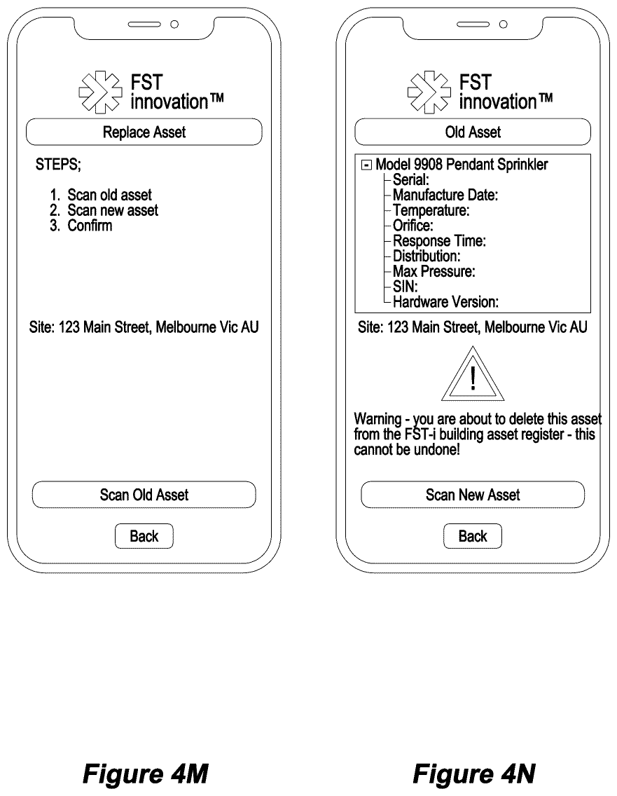

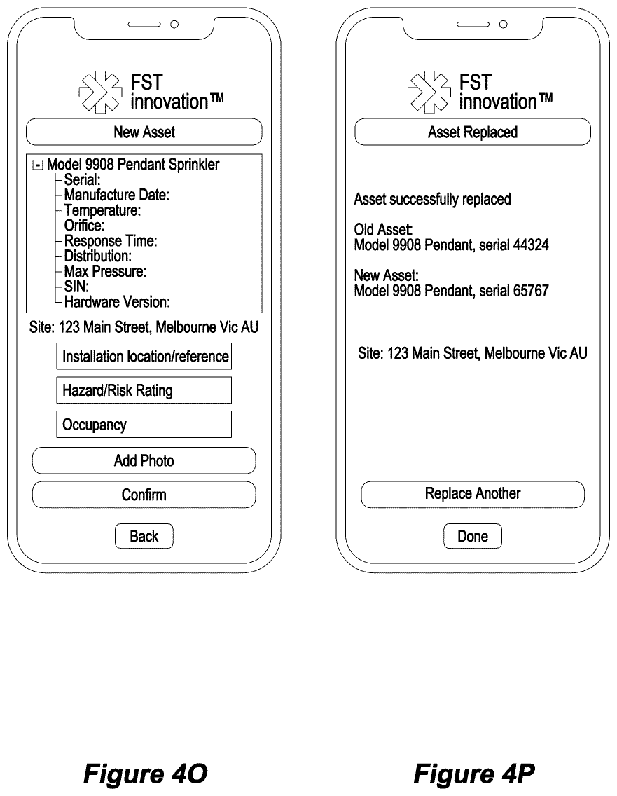

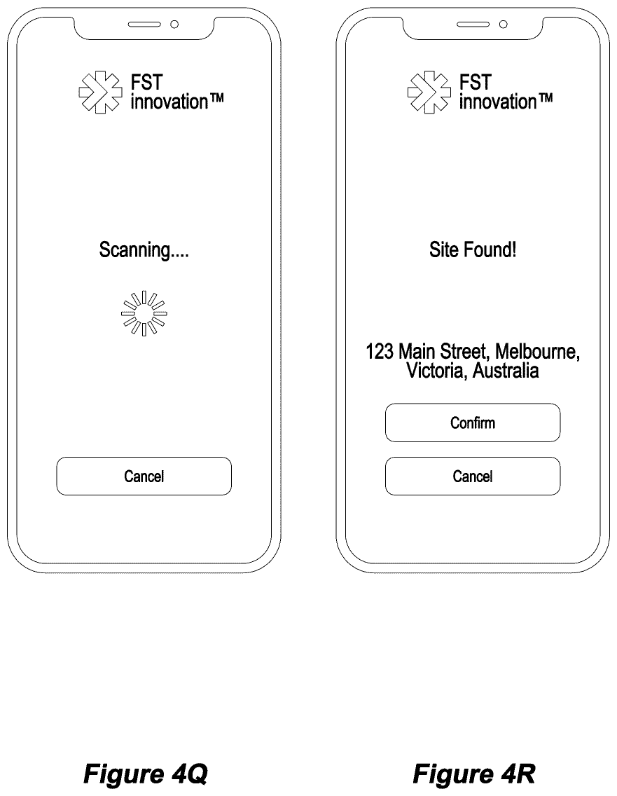

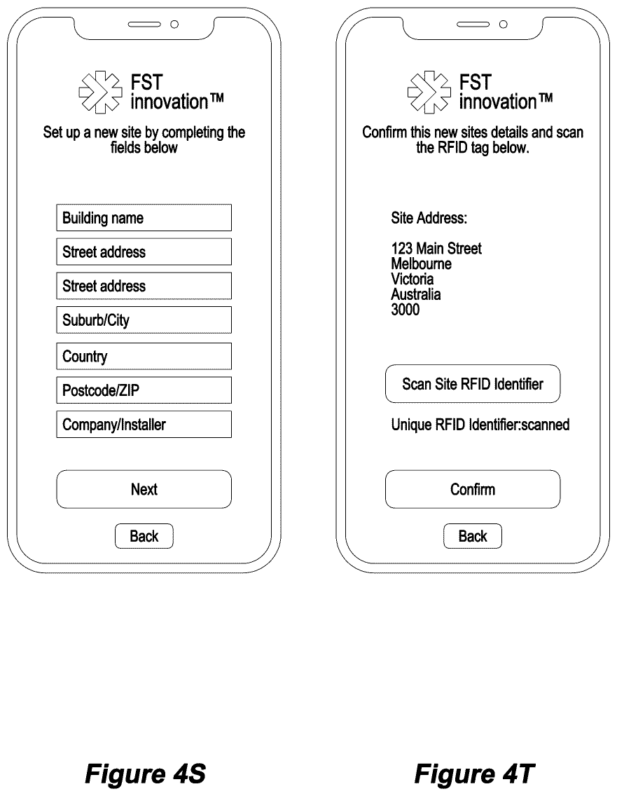

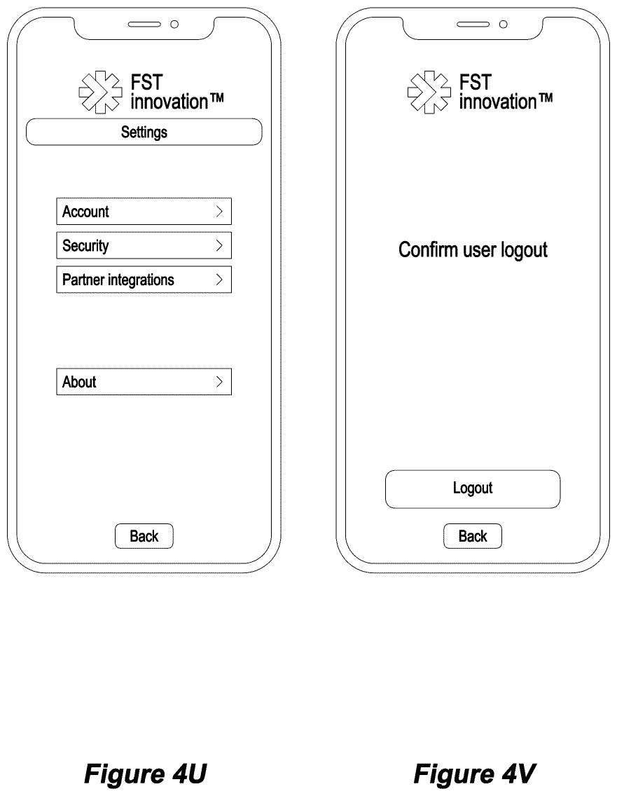

FIGS. 4A to 4V show screen images of a software application running on a reading device 180, in the form of a mobile phone, according to one embodiment of the invention. FIG. 4A shows a welcome screen to allow new user signup or log in of a registered user. FIG. 4B shows a login screen for use by registered users. FIGS. 4C and 4D show registration screens for use by new users and include the ability to collect key contact information.

FIG. 4E and 4F show a log-in screen for registered users and an initial screen display upon login of the user-interface, respectively.

FIG. 4G and 4H show an Asset Inspection and an Asset Identity screen display of the user-interface, respectively. In FIG. 4G, the “fail” button is highlighted.

FIG. 4I and 4J show the Asset Identity screen displaying a “Genuine Asset” indication and an Asset History display of the user-interface, respectively. In FIG. 4I, the “Genuine FST-I Asset” button is highlighted.

FIG. 4K and 4L show the Asset Test and Install Asset displays of the user-interface, respectively.

FIG. 4M and 4N show a Replace Asset display screen and the complementary Old Asset display screen including the Scan New Asset button, respectively.

FIGS. 4O and 4P show a New Asset, featuring an Add Photo button, and an Asset Replaced display screen, respectively.

FIG. 4Q and 4R show a Scanning, or data loading screen, and a Site Found, including the address of the relevant site, display screen, respectively.

FIG. 4S and 4T show a Set Up New Site and Confirm New Site display screen respectively.

FIG. 4U and 4V, respectively, show a Settings and a Confirm User Log Out screen according to the invention.

The invention provides a fire protection system 300 comprising a plurality of machine-readable fire protection assets, such as a plurality of sprinklers 100 and other assets, each asset of the plurality comprising a machine-readable code or tag 140 disposed on the respective machine-readable fire protection asset, the machine-readable code or tag comprising fire protection asset information for the respective machine-readable fire protection asset on which the machine-readable code or tag is disposed, the fire protection asset information comprising a unique identifier for each respective machine-readable fire protection asset.

The system 300 also comprises at least one reading device 180 for reading the machine-readable code or tag 140. The reading device 180 is configured to send and/or receive fire protection asset information from and/or to one or more database 290.

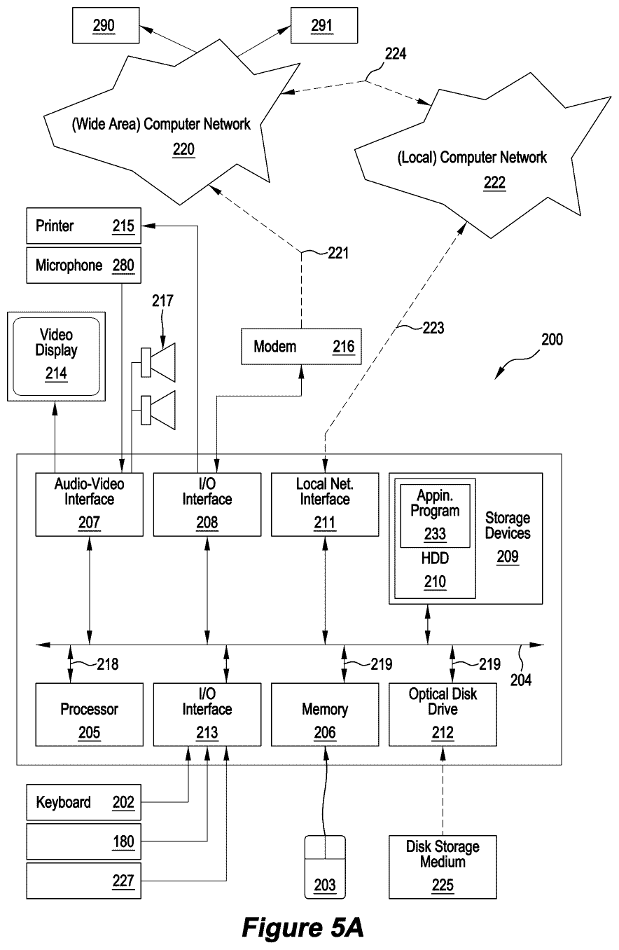

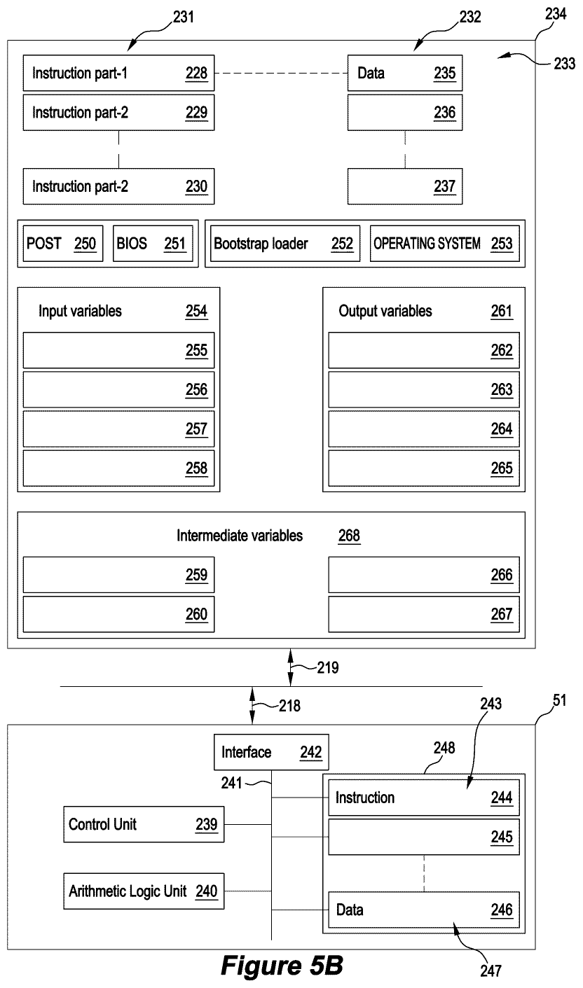

Each database 290 comprises fire protection information and fire protection asset information. The one or more database 290 may be connected to a network, such as network 200 described below and shown in FIG. 5A, for operative communication with the at least one reading device 180. The one or more database 290 may comprise the unique identifier for each respective machine-readable fire protection asset such as, sprinkler 100. The one or more database 290 may be configured to allow entry of additional unique identifiers for additional machine-readable fire protection assets. The entry may be in response to fire protection asset information received from the at least one reading device 180.

From the teaching herein, the skilled person readily understands that the invention also provides a method for installing or establishing a fire protection system 300, the method comprising installing a plurality of machine-readable fire protection assets, such as a plurality of sprinklers 100 and other assets, each asset of the plurality comprising a machine-readable code or tag, such as RFID tag 140, disposed on the respective machine-readable fire protection asset, the machine-readable code or tag comprising fire protection asset information for the respective machine-readable fire protection asset on which the machine-readable code or tag is disposed, the fire protection asset information comprising a unique identifier for each respective machine readable fire protection asset.

The method may further comprise providing at least one reading device 180 for reading the machine-readable code or tag 140, the reading device 180 configured to send and receive fire protection asset information from one or more database 290.

Also provided is a fire safety method comprising reading with a reading device 180 a plurality of machine-readable fire protection assets, such as sprinkler 100, each asset of the plurality comprising a machine-readable code or tag such as, RFID tag 140, disposed on the respective machine-readable fire protection asset, the machine-readable code or tag comprising fire protection asset information for the respective machine-readable fire protection asset on which the machine-readable code or tag is disposed, the fire protection asset information comprising a unique identifier for each respective machine readable fire protection asset.

Advantageously, also provided is a computer-implemented method for determining a fire safety attribute, the method comprising interrogating one or more database comprising fire protection asset information and providing a result extracted from the one or more database, the result comprising at least the unique identifier for each fire protection asset and the fire safety attribute to thereby determine the fire safety attribute.

Also provided is a non-transitory computer program product comprising a computer usable medium and computer readable program code embodied on said computer usable medium for determining a fire safety attribute, the computer readable code comprising computer readable program code devices (i) configured to cause the computer to interrogate one or more database comprising fire protection asset information and computer readable program code devices (ii) configured to cause the computer to provide a result extracted from the one or more database, the result comprising at least the unique identifier for each fire protection asset and the fire safety attribute to thereby determine the fire safety attribute.

A query forming the basis of the interrogation may be received through for example, network 220.

Computer server-based system 300 may also be used to determine a fire safety attribute. The one or more server 291 may receive a query comprising the at least one unique identifier for a machine-readable fire protection asset; a processor to cause the computer to interrogate one or more database 290; and the one or more server 291 may provide a result extracted from the one or more database 290, the result may comprise at least the unique identifier for each fire protection asset and the fire safety attribute to thereby determine the fire safety attribute.

The at least one unique identifier may be received from the one reading device 180.

In a particularly advantageous application, the fire safety attribute determined may comprise counterfeit status or genuine part status. This counterfeit status or genuine part status may be determined using a unique serial number and/or the unique identifier for each fire protection asset. The unique serial number or a concordance may be provided by a remote database such as database. The remote database may comprise a certification agency database. The unique serial number may be received by a certification agency and/or the remote database during or after manufacture of each fire protection asset.

Conveniently, the one or more database 290 may be updated with the unique identifier for each respective machine-readable fire protection asset. This updating may be in response to fire protection asset information received from the at least one reading device 180.

The one or more database 290 may store the fire protection information for the machine-readable fire protection asset and for each respective machine-readable fire protection asset in the plurality of machine-readable fire protection assets. The one or more database 290 may be remotely located. The one or more database 290 may store a larger subset of fire protection information for each fire protection asset than stored on the machine-readable code or tag.

The one or more database 290 may be operated by the same or different entities. For example, one database 290 may be remotely located and may be operated by a certification agency.

The fire protection asset may be located within a privately owned building. The fire protection asset located within a privately owned building may be part of a privately owned fire protection system. The fire protection asset located within a privately owned building may be connected to on-site water or part of a system connected to on-site water. The fire protection asset located within a privately owned building may be connected to water downstream of a water utility network.

Advantageously, the fire protection asset may be automatically activated. The automatic activation may be by a temperature responsive element. The automatic activation may comprise one or more automatically activated alarm. The one or more automatically activated alarm may comprise an external alarm monitoring service and/or the automatic summonsing of fire response such as, a fire brigade crew. The one or more automatically activated alarm may comprise a local alarm or alert in the form of a local audible alarm. One or more, or all components, of the automatically activated alarm may be regulated by a building code and/or standard.

The fire protection asset may be both located within a privately owned building and automatically activated.

The fire protection asset may comprise a sprinkler; a flow meter; a valve such as, a shut off valve, a flow valve, an isolation valve or a drain valve; a gauge; a valve monitor; a pump; a switch such as, a pressure switch or a flow switch; a smoke detector; a siren; a pull station; a control point; an intercom point; a carbon monoxide monitor; a carbon dioxide monitor; a heat detector; or a passive fire protection component. The passive fire protection component may comprise a vertical fire and smoke compartment barrier; a horizontal fire and smoke compartment barrier; a fire-resistant opening; a fire door set including a fire door, including a sliding fire door; a smoke door; a duct; a damper; a fire shutter; an access panel; a hatch; a service penetration; a control joint; a fire-resistant glazing; an alarm; a fire stopping or a structural fire-resistant element such as, a beam, a column and a truss.

Through the large numbers typically employed in fire protection systems, individual fire protection assets may be in the form of a fire sprinkler or fire sprinkler head; or fire sprinkler adaptor. Other common implementations may see fire protection assets in the form of a smoke detector and/or gas detector. The smoke detector and/or gas detector may provide data through a SIM card.

Although not so limited, in the embodiment show in FIG. 1, the machine-readable code or tag is an RFID chip. Other implementations may comprise QR code; a bar code or a SIM card.

From the teaching herein, a skilled person is readily able to select the machine-readable code or tag to be either read only (RO) or read and write (RW). The machine-readable code or tag may comprise any automatic identification and data capture (AIDC) device such as, a SIM card or sensor. The machine-readable code or tag may be active, powered by a battery, or passive, powered by the reading by the one or more reader.

The fire protection information may comprise one or more of: fire protection asset information; and installation location information.

The fire protection asset information may comprise one or more of: product code; manufacturer information; unique serial number; asset type; asset performance data; asset specification data; installation location; installation date data; inspection date; maintenance or service data; batch information; hardware information; frequency of use data; operating environment data; other production information; a photograph; and installer data. The manufacturer information may comprise one or more of: manufacturer name; factory name; and factory location. The installer data may comprise one or more of installer name; installer email, installer company name, installer phone number, installer license and/or accreditation. The frequency of use data may comprise designation of one or both of high-use or constant-use. The operating environment data may comprise designation of adverse operating environment status. The asset specification data may comprise asset warranty and/or asset longevity information. The photograph may comprise a photograph of the fire protection asset before and/or after installation.

The installation location information may comprise one or more of: building address; internal location of the fire-protection asset; risk rating; occupancy type; GPS coordinates; height of the fire-protection asset above the floor; design standard; drawings of the installation location; general drawings; and associated schedules; and reference to a database or list of regulations or standards to confirm compliance. The installation location information may further comprise information required for compliance for the installation location such as, state or country location; and approved fire protection assets. The information required for compliance may comprise adequate documentation to conduct an inspection. The general drawings may be marked with relevant fire protection information.

The internal location may comprise a floor and/or room. The risk rating may be a risk rating of one or more of the installation room; the installation area; the installation floor, and installation building. The design standard may be a design standard for the fire-protection asset dictated by the installation location or a regulation or code determined by the installation location.

Advantageously, the unique identifier may be used to query the one or more database 290 to identify the installation location where the relevant fire-protection asset is installed. The identification of the installation location may permit access to change the fire protection information in the one or more database 290 for each respective fire-protection asset associated with the identified installation location.

The installation location information may be reviewed to provide an approved replacement fire protection asset when replacement is required or detected to be required.

The maintenance or service data may comprise a level of maintenance or service data and/or a frequency of maintenance or service data.

The fire protection asset information may be programmed into the code or tag at the time of manufacture of the machine-readable fire-protection asset or of the code or tag. The fire protection asset information, or a subset thereof, may be indelible and/or password protected. The subset may comprise serial number and/or a unique identification.

The machine-readable code or tag may comprise any automatic identification and data capture format.

The invention allows the one or more database to be queried by one or more of the fire protection asset information and/or one or more of the installation location information. The query may be received and a response prepared, the response comprising all information in the one or more database associated with the queried one or more of the fire protection asset information and/or the installation location information.

The device or system may further comprise the one or more database 290 providing an electronic alert when a date or time-period associated with the stored one or more of the fire protection asset information and/or the one or more installation location information stored in the one or more database 290. The date or time-period may be associated with one or more of inspection; testing; maintenance; and replacement activities.

Another application is to query the fire protection information and/or fire protection asset information to provide a desired output. The desired output may comprise identification and/or listing of the fire protection assets associated with the query.

A message may be sent and/or an alert produced when a date is within a reminder period. The data may comprise end of warranty; expiry date or end of asset longevity date. The reminder period may comprise one or more of six months; three months; one month; two weeks; and one week.

In one particularly advantageous demonstration of the practical effect of the invention, a report detailing the received and/or sent fire protection asset information or a subset thereof may be provided. The report may further contain other information from the one or more database 290. The report may be provided electronically. An asset that is subject to a recall or installation advisory note or changed maintenance or inspection practices can be located more readily and the risks of such a change or event going unactioned are mitigated.

In yet another particularly advantageous embodiment of any of the above aspects, a message may be sent and/or an alert produced when the asset is identified as being subject to a recall or other installation advisory note. The other installation advisory note may comprise one or both of: a changed maintenance or inspection practise and identification of counterfeit fire-protection asset.

In still another particularly advantageous embodiment of any one of the above aspects, a message may be sent and/or an alert produced when an action is determined to be overdue. The action may comprise one or more of: inspection; testing; maintenance; and other integrity process.

One embodiment of a personal device 200 suitable for use as a reading device 180 in the present invention is shown in FIGS. 5A and 5B. In the embodiment shown personal device 200 comprises a computer module 201 comprising input devices such as a keyboard 202, a mouse pointer device 203, a reading device 180, an external hard drive 227, and a microphone 280; and output devices including a printer 215, a display device 214 and loudspeakers 217. In some embodiments video display 214 may comprise a touchscreen.

A Modulator-Demodulator (Modem) transceiver device 216 may be used by the computer module 201 for communicating to and from a communications network 220 via a connection 221. The network 220 may be a wide-area network (WAN), such as the Internet, a cellular telecommunications network, or a private WAN. Through the network 220, computer module 201 may be connected to one or more databases 290 or computers 291 which may be a server computer or other computer such as, a remotely located user terminal. Where the connection 221 is a telephone line, the modem 216 may be a traditional “dial-up” modem. Alternatively, where the connection 221 is a high capacity (e.g.: cable) connection, the modem 216 may be a broadband modem. A wireless modem may also be used for wireless connection to network 220.

The computer module 201 typically includes at least one processor 205, and a memory 206 for example formed from semiconductor random access memory (RAM) and semiconductor read only memory (ROM). The module 201 also includes a number of input/output (I/O) interfaces including: an audio-video interface 207 that couples to the video display 214, loudspeakers 217 and microphone 280; an I/O interface 213 for the keyboard 202, mouse 203, reading device 180 and external hard drive 227; and an interface 208 for the external modem 216 and printer 215. In some implementations, modem 216 may be incorporated within the computer module 201, for example within the interface 208. The computer module 201 also has a local network interface 211 which, via a connection 223, permits coupling of the personal device 200 to a local computer network 222, known as a Local Area Network (LAN).

As also illustrated, the local network 222 may also couple to the wide network 220 via a connection 224, which would typically include a so-called “firewall” device or device of similar functionality. The interface 211 may be formed by an Ethernet circuit card,, WiFi, including WiFi HaLow, a Bluetooth wireless arrangement or an IEEE 802.11 wireless arrangement or other suitable interface, such as Zigbee and Morse Micro, which may be implemented in (Industrial) Internet of Things ((I)IoT) or home automation technology.

The I/O interfaces 208 and 213 may afford either or both of serial and parallel connectivity, the former typically being implemented according to the Universal Serial Bus (USB) standards and having corresponding USB connectors (not illustrated).

Storage devices 209 are provided and typically include a hard disk drive (HDD) 210. Other storage devices such as, an external HD 227, a disk drive (not shown) and a magnetic tape drive (not shown) may also be used. An optical disk drive 212 is typically provided to act as a non-volatile source of data. Portable memory devices, such as optical disks (e.g.: CD-ROM, DVD, Blu-Ray Disc), USB-RAM, external hard drives and floppy disks for example, may be used as appropriate sources of data to the personal device 200. Another source of data to personal device 200 is provided by the at least one server computer 291 through network 220.

The components 205 to 213 of the computer module 201 typically communicate via an interconnected bus 204 in a manner that results in a conventional mode of operation of personal device 200. In the embodiment shown in FIGS. 5A and 5B, processor 205 is coupled to system bus 204 through connections 218. Similarly, memory 206 and optical disk drive 212 are coupled to the system bus 204 by connections 219. Examples of personal devices 200 on which the described arrangements can be practiced include IBM-PC's and compatibles, Sun Sparc stations, Apple computers; smart phones; tablet computers or like a device comprising a computer module like computer module 201 or (Industrial) Internet of Things ((I)IoT) home automation technology such as, zigbee and morse micro access points and/or connected devices. It is to be understood that when personal device 200 comprises a smart phone or a tablet computer, display device 214 may comprise a touchscreen and other input and output devices may not be included such as, mouse pointer device 203; keyboard 202; reading device 180; and printer 215.

FIG. 5B is a detailed schematic block diagram of processor 205 and a memory 234. The memory 234 represents a logical aggregation of all the memory modules, including the storage device 209 and semiconductor memory 206, which can be accessed by the computer module 201 in FIG. 5A.

The methods of the invention may be implemented using personal device 200 wherein the methods may be implemented as one or more software application programs 233 executable within computer module 201. In particular, the steps of the methods of the invention may be effected by instructions 231 in the software carried out within the computer module 201.

The software instructions 231 may be formed as one or more code modules, each for performing one or more particular tasks. The software 233 may also be divided into two separate parts, in which a first part and the corresponding code modules performs the method of the invention and a second part and the corresponding code modules manage a graphical user interface between the first part and the user.

The software 233 may be stored in a computer readable medium, including in a storage device of a type described herein. The software is loaded into the personal device 200 from the computer readable medium or through network 221 or 223, and then executed by personal device 200. In one example the software 233 is stored on storage medium 225 that is read by optical disk drive 212. Software 233 is typically stored in the HDD 210 or the memory 206.

A computer readable medium having such software 233 or computer program recorded on it is a computer program product. The use of the computer program product in the personal device 200 preferably effects a device or apparatus for implementing the methods of the invention.

In some instances, the software application programs 233 may be supplied to the user encoded on one or more disk storage medium 225 such as a CD-ROM, DVD or Blu-Ray disc, and read via the corresponding drive 212, or alternatively may be read by the user from the networks 220 or 222. Still further, the software can also be loaded into the personal device 200 from other computer readable media. Computer readable storage media refers to any non-transitory tangible storage medium that provides recorded instructions and/or data to the computer module 201 or personal device 200 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software application programs 233, instructions 231 and/or data to the computer module 201 include radio or infra-red transmission channels as well as a network connection 221, 223, 334, to another computer, another networked one or more database 290, or server computers 291 and the Internet or an Intranet including email transmissions and information recorded on Websites and the like.

The second part of the application programs 233 and the corresponding code modules mentioned above may be executed to implement one or more graphical user interfaces (GUIs) to be rendered or otherwise represented upon display 214. Through manipulation of, typically, keyboard 202, mouse 203 and/or screen 214 when comprising a touchscreen, a user of personal device 200 and the methods of the invention may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers 217 and user voice commands input via microphone 280. The manipulations including mouse clicks, screen touches, speech prompts and/or user voice commands may be transmitted via network 220 or 222.

When the computer module 201 is initially powered up, a power-on self-test.

(POST) program 250 may execute. The POST program 250 is typically stored in a ROM 249 of the semiconductor memory 206. A hardware device such as the ROM 249 is sometimes referred to as firmware. The POST program 250 examines hardware within the computer module 201 to ensure proper functioning, and typically checks processor 205, memory 234 (209, 206), and a basic input-output systems software (BIOS) module 251, also typically stored in ROM 249, for correct operation. Once the POST program 250 has run successfully, BIOS 251 activates hard disk drive 210. Activation of hard disk drive 210 causes a bootstrap loader program 252 that is resident on hard disk drive 210 to execute via processor 205. This loads an operating system 253 into RAM memory 206 upon which operating system 253 commences operation. Operating system 253 is a system level application, executable by processor 205, to fulfill various high level functions, including processor management, memory management, device management, storage management, software application interface, and generic user interface.

Operating system 253 manages memory 234 (209, 206) in order to ensure that each process or application running on computer module 201 has sufficient memory in which to execute without colliding with memory allocated to another process. Furthermore, the different types of memory available in the personal device 200 must be used properly so that each process can run effectively. Accordingly, the aggregated memory 234 is not intended to illustrate how particular segments of memory are allocated, but rather to provide a general view of the memory accessible by computer module 201 and how such is used.

Processor 205 includes a number of functional modules including a control unit 239, an arithmetic logic unit (ALU) 240, and a local or internal memory 248, sometimes called a cache memory. The cache memory 248 typically includes a number of storage registers 244, 245, 246 in a register section storing data 247. One or more internal busses 241 functionally interconnect these functional modules. The processor 205 typically also has one or more interfaces 242 for communicating with external devices via the system bus 204, using a connection 218. The memory 234 is connected to the bus 204 by connection 219.

Application program 233 includes a sequence of instructions 231 that may include conditional branch and loop instructions. Program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, processor 205 is given a set of instructions 243 which are executed therein. The processor 205 then waits for a subsequent input, to which processor 205 reacts by executing another set of instructions. Each input may be provided from one or more of a number of sources, including data generated by one or more of the input devices 202, 203, or 214 when comprising a touchscreen, data received from an external source across one of the networks 220, 222, data retrieved from one of the storage devices 206, 209 or data retrieved from a storage medium 225 inserted into the corresponding reader 212. The execution of a set of the instructions may in some cases result in output of data. Execution may also involve storing data or variables to the memory 234.

The disclosed arrangements use input variables 254 that are stored in the memory 234 in corresponding memory locations 255, 256, 257, 258. The described arrangements produce output variables 261 that are stored in the memory 234 in corresponding memory locations 262, 263, 264, 265. Intermediate variables 268 may be stored in memory locations 259, 260, 266 and 267.

The register section 244, 245, 246, the arithmetic logic unit (ALU) 240, and the control unit 239 of the processor 205 work together to perform sequences of micro-operations needed to perform “fetch, decode, and execute” cycles for every instruction in the instruction set making up the program 233. Each fetch, decode, and execute cycle comprises:
(a) a fetch operation, which fetches or reads an instruction 231 from memory location 228, 229, 230;
(b) a decode operation in which control unit 239 determines which instruction has been fetched; and
(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the methods of the invention may be associated with one or more segments of the program 233, and may be performed by register section 244-246, the ALU 240, and the control unit 239 in the processor 205 working together to perform the fetch, decode, and execute cycles for every instruction in the instruction set for the noted segments of program 233.

One or more databases 290 may be connected to the communications network 220 as seen in FIG. 5A.

One or more other server computer 291 may be connected to the communications network 220. These server computers 291 respond to requests from the personal device or other server computers to provide information.

Method 100 may alternatively be implemented in dedicated hardware such as one or more integrated circuits performing the functions or sub functions of the described methods. Such dedicated hardware may include graphic processors, digital signal processors, or one or more microprocessors and associated memories.

It will be understood that in order to practice the methods of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it will be understood that each of the processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. It will be understood, however, that the processing performed by two distinct components as described above may, in accordance with a further embodiment of the invention be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, a telecommunications network (e.g., a cellular or wireless network) or any client server system that provides communication, for example. Such communications technologies may use any suitable protocol such as TCP/IP, UDP, or OSI, for example.

The following non-limiting examples illustrate the invention. These examples should not be construed as limiting: the examples are included for the purposes of illustration only. The Examples will be understood to represent an exemplification of the invention.

### EXAMPLES

Centralised record keeping: Data can be linked to a site, to an installer, to a maintenance company, and to a maintainer to allow portability in asset maintenance records keeping. In this example the fire protection information may be used to prepare reports on un-inspected assets in a site location, or to determine the presence of mismatched FPS assets compared to site use (e.g., materials storage risks).

The invention has advantages in terms of traceability, accessibility and accountability for building owners, maintainers, and insurers.

Counterfeit devices: counterfeit sprinkler heads do not function properly when needed. This leads to increased risk to building and occupants during a fire. The identification of counterfeit sprinklers requires all such sprinklers to be immediately replaced. This has increased risk. The affected parties include suppliers, manufacturers, building owners, installers, insurers, and occupants. The total replacement of all sprinklers in a building is non-trivial and is very expensive.

Integration with fire asset maintenance software packages: the invention may be integrated with job management, logbook keeping, billing, scheduling and client management. This aids in reporting and defect rectification and leads to advantages in cost, efficiency, visibility, and accountability. The benefits here flow to the installer, service company, insurer, building owner and tenant.

Inability to identify sprinkler asset once installed: Very limited identification data can be stamped on a sprinkler. The limited marking is typically in letter sizes difficult to read when new and extremely difficult when installed in ceilings and covered in the typical grime for years in service. The invention provides definitive device capability and ID during inspections and audits. This reduces risk, provides traceability, which benefits the installer, maintainer, building owner, and insurer.

Qualifications of installer and/or maintainers: the installation and maintenance records may advantageously be linked to an individual installer and maintainer, including records of their relevant license or qualification to ensure works are performed and signed off by accredited persons. This is advantageous in terms of risk and compliance, which benefits the building owner and the insurer.

Collection of installation data: the sale of additional services based on sprinkler location, type, etc may be conducted.

Collection of installer data: as part of the on-boarding process, installer data such as, name, email, company, phone number, license and/or accreditation may be collected, and this may be used to offer additional services and updates to the installer. This could be segmented to focus on installers working in different industries or building types.

Validation of installation vs design: the invention may help prevent incorrect sprinkler installation against design intent. The large number of types available mean it is easy to select a sprinkler type that is not suitable or does not meet the safety and/or regulatory requirements of a particular installation location. Such a validity check may be conducted automatically upon scanning of a code or tag on an installed asset or reference may be made to sprinkler part number, rating, type, datasheet and/or performance against the building design documentation to confirm a suitable sprinkler type is installed. This is a powerful advantage when integrated with a visual representation of the floor plan and/or sprinkler design. This advantageously reduces risk to benefit the installer, insurer, and system certifier.

Investigations: the invention may provide investigators an auditable digital record of sprinkler system maintenance, configuration, and inspection. This advantageously reduces risk and benefits the insurer and any relevant building authority.

Verification of works: Advantageously, the invention may provide serial numbers and types of components installed for use in invoicing and as proof of work and/or certification such as, Certificate of Origin (CoO). This has benefits in terms of risk and traceability for the maintainer.

Complement SIN: all sprinklers are required to have a Sprinkler Identification Number (SIN). The implementation of the global SIN registry was necessary two decades ago however the method of marking the sprinkler with unique number limited to only four digits is far too limiting now that the range of sprinkler head types has increased dramatically since the original. The invention may potentially replace the SIN with an industry standard which is a flexible, data-rich method of uniquely identifying sprinklers.

Traceability: The invention may allow traceability in terms of tracking of assets such as, sprinkler (head) manufacture, supply chain handling, distribution, testing and installation. This can all be tracked, including certification, to the benefit of the industry.

Confirmation of site attendance: The RFID can be used to confirm maintainer attendance at a site, which cannot be copied like a QR code. This has advantages in terms of traceability for the building owner and insurer and is likely to improve system testing compliance.

Confirmation of inspection of sprinklers in Apartments or particular areas of a site: No method currently exists to validate that sprinklers are inspected inside individual apartments. The invention may allow this to provide traceability to the benefit of the occupant.

The device and system of the present invention provides several key high-level benefits compared to existing solutions and existing maintenance practices. These include the following:
Identification—the ability to definitively identify the fire protection asset including the ability to assist in identifying compatible replacement parts.
Design certification—the risk of accidently not detecting an incorrect type of fire protection asset is greatly reduced.
Fire protection asset type certification—fire protection asset assets may be confirmed as complying with specific standards through positive identification.
Serialisation—fire protection asset assets may be individually identified where presently they are only typically identifiable by make and model.
Traceability—fire protection assets may be tracked from manufacture through to installation and routine use without need for reference back to purchase or vendor manufacture records.
Authenticity—fire protection assets can be confirmed as being authentic in a market where—in some countries—counterfeit or non-compliant devices are widely used.
Auditability—fire protection asset assets may be positively identified, queried, and confirmed as fit for the intended purpose by the maintainer.
Defect tracking—defects in fire protection assets may be tracked to manufacturer, manufacture date, hardware version, installation date, and the installers themselves.
Product recall management—fire protection assets may be more readily tracked to a specific installation location in the event of a recall or other change such as a regulatory or standard change.
Inspection rigor—fire protection assets never inspected may be identified and routine inspections scheduled based on risk, standards requirements, or internal policy.
Proof of attendance—fire protection assets cannot be tagged as inspected without physically attending the site.

The invention has the potential to become a new Industry Asset Management Standard. An FPS industry database and registration system of sprinkler heads—the SIN—is mandated in compliance standards. This SIN is a 4- or 5-character serial number and provides basic information on a sprinkler head's identity, including: a one or two-character manufacturer code; and a four-character model number. The SIN character codes for model numbers are not standardized, free-form, and inconsistently used by manufacturers. No serialization of individual items is possible and each unique SIN allocated to a product line requires a new stamp tool to be produce for only that SIN number. This has resulted in manufacturers not being able to categorize sprinklers in useful groupings using uniquely identifiable markings. An opportunity exists to improve some of these processes using codes or tags such as, RFID tags or similar data-carrying asset management tags or codes to provide definitive identification and verification of fire protection assets, and to further collect and maintain accurate installation records of fire protection assets-including when, where, what type, and by whom the fire protection asset was installed. Maintenance and inspection activities can be verified and recorded, either on-tag or on-server, credential status of trades confirmed, and individual serialization, manufacture information, and authenticity may also be determined.

Such an RFID-based fire protection asset management system may provide a platform or industry incentive to upgrade or replace the SIN registration database with the potential to become a new industry standard or industry standard way of managing FPS compliance.

The system may facilitate data sharing via a publicly, or via authenticated subscription model, network API interface for integration with third party job scheduling, fire protection asset maintenance software, and mobile trades management applications. Moreover, data may be shared with regulators and other industry participants, including fire protection asset maintainers, installers, and manufacturers, using the same or similar identification approach to improve fire protection asset maintenance practices.

Various technologies may be used to store and retrieve the data on the fire protection asset, including both Near Field Communications (NFC) and Radio Frequency Identification (RFID), or other means of data storage and retrieval whether contact or non-contact based.

Advantageously, the present invention provides improved certification and improved maintenance coverage in for example, identifying sprinklers that have not been inspected, which may reduce the problems associated with fire sprinkler and fire sprinkler system failures. These improvements will have many advantages, including those summarised below and herein generally.

The invention may advantageously reduce unintended operation due to installation or maintenance error. This would be valuable given that between the years 2015 and 2019 in the US, there were on average 26,000 sprinkler activations caused by a system failure or malfunction per year (excluding accidental or unintended activation⁴). For context, anecdotally, it costs between $1,000 and $2,000 per minute in damages from an unintended sprinkler system activation^{5,6}.

Additionally, the invention may eliminate, or at least reduce, the instances of inoperability due to incorrect selection at installation or maintenance error. It has been reported that change of occupancy can be catastrophic if a fire protection asset such as, a sprinkler system is not updated and checked for suitability. Just one example is that of a warehouse fire in the US which did US$110 million in damage to a GE facility in 2015⁷.

Another advantage provided by the invention is in terms of recall scope and cost. To highlight this advantage, consider that in the year 1999, 8.4 million sprinklers were recalled under a voluntary program due to a large percentage of the sprinklers failing periodic testing. This resulted in seventeen known fires and US$4.3 million in property damages and four known injuries from the sprinklers failing to operate properly⁸. Additionally, in 2001, 35 million sprinklers were recalled due to the sprinkler head O-ring seals degrading to the point where they may fail to operate during a fire. This was at the time the third largest product recall in US CPSC history⁹. Being able to identify where recalled sprinklers are installed is likely to make the process of any future recalls far simpler to manage, reducing risk to property and occupants but also sprinkler head manufacturers.

A further demonstrable advantage is in terms of effectively dealing with non-compliant sprinkler systems. For instance, recently, the National Fire Sprinkler Association (NFSA) wrote to Amazon requesting that non-compliant non-certified sprinkler heads be removed from sale. Additionally, it has been reported by the International Fire Suppression Alliance (IFSA) that Brazil has an increasing level of non-certified sprinkler heads—up to 70%. Being able to verify a fire suppression asset, as authentic as certified by a reputable manufacturer may reduce the prevalence of noncompliant systems and the associated costs and risks.

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

### REFERENCES

1 Source: NFPA Research “US experience with sprinklers”, Marty Ahrens, October 2021, pp 6-7, pp 9.
2 ibid., pp 6-7, pp 15 and Table 9.
3 ibid., pp 6-7, pp 15 and Table 4.
4 ibid. p 9.
5 https://www.qrfs.com/blog/213-fire-sprinkler-accidents-the-top-5-causes-of-discharges-andleaks/
6 https://shutgun.ca/fire-sprinkler-accidents-5causes-and-how-to-fix-them/
7 https://www.nfpa.org/News-and-Research/Publications-and-media/NFPA-Journal/2017/March-April-2017/Features/GEWarehouse-Fire
8 https://www.cpsc.gov/Recalls/1999/CPSC-Central-Sprinkler-Recall-Omega-Fire-SprinklersSettle-Lawsuit
9 https://www.cpsc.gov/Recalls/2001/cpsc-centralsprinkler-company-announce-voluntary-recall-toreplace-o-ring-fire
10 https://www.youtube.com/watch?v=C6MfTcjP6oU
11 https://nfsa.org/2020/06/11/non-compliant-firesprinkler-products-sold-on-amazon-posesignificant-risk-to-public/

The invention claimed is:

1. (canceled)

2. A fire protection system comprising:
a plurality of machine-readable fire protection assets, each asset of the plurality comprising a machine-readable code or tag disposed on the respective machine-readable fire protection asset, the machine-readable code or tag comprising fire protection asset information for the respective machine-readable fire protection asset on which the machine-readable code or tag is disposed, the fire protection asset information comprising a unique identifier for each respective machine-readable fire protection asset; and
at least one reading device for reading the machine-readable code or tag, the reading device configured to send and/or receive fire protection asset information from and/or to one or more database;
wherein the fire safety attribute comprises counterfeit status or genuine part status and/or the fire protection asset information comprises one or more of manufacturer information; installation location; installation date data; installer data; and
asset performance data.

3. The system of claim 2 further comprising the one or more database comprising fire protection information and fire protection asset information.

4. (canceled)

5. (canceled)

6. A computer-implemented method for determining a fire safety attribute of a fire protection asset, the method comprising:
interrogating one or more database comprising fire protection asset information, the fire protection asset information comprising a unique identifier for each fire protection asset; and
providing a result extracted from the one or more database, the result comprising at least the unique identifier for each fire protection asset and the fire safety attribute to thereby determine the fire safety attribute,
wherein the fire safety attribute comprises counterfeit status or genuine part status and/or the fire protection asset information comprises one or more of manufacturer information, installation location, installation date data, installer data, and asset performance data.

7. A non-transitory computer program product comprising:
a computer usable medium and computer readable program code embodied on said computer usable medium for determining a fire safety attribute of a fire protection asset, the computer readable code comprising:
computer readable program code devices (i) configured to cause the computer to interrogate one or more database comprising fire protection asset information, the fire protection asset information comprising a unique identifier for each fire protection asset; and
computer readable program code devices (ii) configured to cause the computer to provide a result extracted from the one or more database, the result comprising at least the unique identifier for each fire protection asset and the fire safety attribute to thereby determine the fire safety attribute,
wherein the fire safety attribute comprises counterfeit status or genuine part status and/or the fire protection asset information comprises one or more of manufacturer information, installation location, installation date data, installer data, and asset performance data.

8. A computer server-based system for determining a fire safety attribute of a fire protection asset, the system comprising:
one or more server adapted to receive a query comprising at least one unique identifier for a machine-readable fire protection asset;
a processor to cause the computer to interrogate one or more database comprising fire protection asset information, the fire protection asset information comprising a unique identifier for each fire protection asset, the interrogation based on the received query; and
the one or more server adapted to provide a result extracted from the one or more database, the result comprising at least the unique identifier for each fire protection asset and the fire safety attribute to thereby determine the fire safety attribute,
wherein the fire safety attribute comprises counterfeit status or genuine part status and/or the fire protection asset information comprises one or more of manufacturer information, installation location, installation date data, installer data, and asset performance data.

9. (canceled)

10. The system according to claim 2 wherein the fire protection asset is automatically activated by: a temperature responsive element, or an automatically activated alarm.

11. The system according to claim 2 wherein the fire protection asset comprises a sprinkler; a flow meter; a valve such as, a shut off valve, a flow valve, an isolation valve or a drain valve; a gauge; a valve monitor; a pump; a switch such as, a pressure switch or a flow switch; a smoke detector; a siren; a pull station; a control point; an intercom point; a carbon monoxide monitor; a carbon dioxide monitor; a heat detector; or a passive fire protection component.

12. The system according to claim 2 wherein the fire protection asset is a fire sprinkler or fire sprinkler head; or fire sprinkler adaptor.

13. The system according to claim 2 wherein the machine-readable code or tag is one or more of an RFID chip; a QR code; a bar code or a SIM card.

14. The system according claim 2 wherein the fire protection asset information comprises installation location information.

15. (canceled)

16. The system according to claim 14 wherein the installation location information comprises one or more of: building address; internal location of the fire-protection asset; risk rating; occupancy type; GPS coordinates; height of the fire-protection asset above the floor; design standard; drawings of the installation location; general drawings; and associated schedules; and reference to a database or list of regulations or standards to confirm compliance.

17. (canceled)

18. (canceled)

19. The system according claim 14 wherein the one or more database provides an electronic alert on a date or time-period associated with the stored one or more of the fire protection asset information and/or the one or more installation location information stored in the one or more database.

20. (canceled)

21. The system according to claim 2 wherein the counterfeit status or genuine part status is determined using a unique serial number and/or the unique identifier for each fire protection asset.

22. The system according to claim 2 wherein the one or more database comprises a certification agency database.

23. The system according to any claim 14 wherein the fire protection asset information comprises one or more of: unique serial number; asset type; asset specification data; batch information; hardware information; frequency of use data;
operating environment data; other production information; a photograph; and installer data.

24. The system according claim 23 wherein the asset specification data comprises asset warranty and/or asset longevity information.

25. The system according claim 14 wherein the installation location information is reviewed to provide an approved replacement fire protection asset when replacement is required or detected to be required.

26. The system according to claim 2 wherein the one or more database shares data with a regulator and/or other industry participants.

27. The system according to claim 2 the fire protection asset is positively identified, queried, and confirmed as fit for the intended purpose.
